(19) United States
(12) Patent Application Publication
(10) Pub. No.: US 2014/0290797 A1
(43) Pub. Date: Oct. 2, 2014

(54) ARRANGEMENT FOR STORING AND EXTRACTING COMPRESSED GAS

(71) Applicants: Alexander Kriese, Baden bei Wien (AT); Wolfgang Wolter, Goch-Asperden (DE)

(72) Inventors: Alexander Kriese, Baden bei Wien (AT); Wolfgang Wolter, Goch-Asperden (DE)

(73) Assignees: WYSTRACH GMBH, Weeze (DE); MESSER GASPACK GMBH, Krefeld (DE)

(21) Appl. No.: 14/005,417

(22) PCT Filed: Mar. 6, 2012
(86) PCT No.: PCT/EP2012/053792

§ 371 Date: Nov. 12, 2013

(30) Foreign Application Priority Data
Mar. 16, 2011 (DE) 10 2011 014 065.4

(51) Int. Cl. F17C 13/00; F17C 13/04; F17C 13/08

(52) U.S. Cl. CPC F17C 13/002; F17C 13/084; F17C 13/04
USPC 141/99; 141/237

(57) ABSTRACT

A gas supply pipeline system having at least two outlets which are designed in each case for different pressures, for example for 300 bar and for 200 bar. For this purpose, at least one of the outlets is equipped with a valve for pressure reduction. In this way, the extraction of gas at different extraction pressures is possible with one arrangement.

The invention relates to an arrangement for storing and transporting compressed gas, having a plurality of compressed gas cylinders which are mounted in a frame, a pipeline system which is connected to the compressed gas cylinders, and a removal connector which is assigned to the pipeline system.

Compressed gas cylinders which are manufactured as a rule from steel, aluminum or a composite material are used to store and transport gases. Nowadays, compressed gas cylinders are available with different filling volumes between 10 and 50 liters and authorized filling pressures between 150 and 300 bar or over. Customers with a relatively high gas requirement are usually supplied by way of what are known as cylinder bundles. These are an arrangement of from 6 to 28 commercially available compressed gas cylinders in each case with a filling volume of from 40 to 50 liters which are installed fixedly in a frame. The compressed gas cylinders are connected among one another by way of a pipeline system and have one or more connectors which are used both for removal of the gas at the customer and for refilling the cylinder bundle at the filling facility. Cylinder bundles for combustible gases or for oxygen are equipped with additional securing systems, for example protective grilles or special pipeline fittings. Cylinder bundles for compressed gas cylinders have already been known for a long time; a relatively new pipeline system for systems of this type is described, for example, in DE 20 2004 000 771 U1.

Compressed gas cylinder bundles are usually marketed in two pressure stages. Whereas a removal pressure of 200 bar used to be standard, cylinder bundles having a removal pressure of 300 bar have been entering the market increasingly since the middle of the 90s. High pressure systems up to 500 bar or more are available for special applications. Systems with a higher pressure have the advantage that a greater quantity of gas is available to the customer and the logistical outlay on delivery for the supplier is correspondingly lower. However, the problem occurs for many customers that a gas supply using 300 bar bundles is not possible, since the fittings which are connected downstream of the gas supply and gas-consuming devices in the gas supply system at the customer are not authorized for 300 bar. The outlay which is required to replace said fittings and devices often exceeds the additional benefit, with the result that said customers have to continue to be supplied with cylinder bundles, the removal pressure of which is limited to 200 bar.

It is therefore an object of the invention to provide a simple gas supply with compressed gas cylinder bundles, which gas supply makes it possible to supply customers with different system pressures.

In an arrangement of the type mentioned at the outset, this object is achieved by virtue of the fact that the pipeline system is equipped with at least two removal connectors, at least one removal connector being assigned a fitting for pressure reduction for the possibility to remove gas at different removal pressures.

According to the invention, one of the removal connectors is therefore provided for a higher pressure which, in the simplest case, at the same time corresponds to the maximum filling pressure of the gas cylinders of the cylinder bundle. In addition, there is at least one further removal connector which is equipped with a fitting for pressure reduction and at which the gas can be removed at a lower pressure. Depending on the maximum pressure which is authorized in a gas supply system of a customer, the gas supply system is connected to one of the removal connectors. Every customer can therefore in principle be supplied with a cylinder bundle at an identically high filling pressure, that is to say, for example, at 300 bar. At the removal connector or connectors which is/are equipped with a fitting for pressure reduction, the gas can be removed at a lower pressure of, for example, 200 bar or 150 bar. As a result, the logistical outlay for the producer and/or supplier is reduced considerably. It is of course also possible within the context of the invention to provide fittings for pressure reduction at all removal connectors, which fittings for pressure reduction then correspondingly allow the removal of gas at different removal pressures below the filling pressure in the cylinder bundle.

The arrangement according to the invention is of simple construction and does not have a greater space requirement than customary cylinder bundles. The pipeline system comprises hoses and/or pipes which are made from plastic or metal and connect the individual gas cylinders of the cylinder bundle to a distributor fitting, to which the removal connectors are in turn connected. The fitting for pressure reduction is connected downstream thereof as a separate component, that is to say separated therefrom by a connector and/or a pipe piece; said fitting for pressure reduction can be arranged in each case upstream of a shut-off fitting which closes the removal connector or else between the removal connector and a shut-off fitting. The arrangement according to the invention is suitable for all vertically or horizontally arranged cylinder bundles with, for example, 6, 8, 12, 18, 24 or 28 cylinders and for all types of compressed gases, such as atmospheric gases, combustible gases or medical gases.

It is conceivable by way of the arrangement according to the invention, at least for future applications, to fill the cylinder bundles at a very high pressure of 500 bar or more, in order to supply consumers with gas at a removal pressure of 300 bar or 200 bar. One preferred arrangement provides, however, that the gas cylinders are filled at a filling pressure of 300 bar and removal connectors are provided which allow the removal optionally at 300 bar or 200 bar. It goes without saying that pressure reducing devices with an adjustable secondary pressure can also be used within the scope of the invention.

One advantageous refinement of the invention provides that the pressure limiting device/devices is/are arranged as (a) separate fitting/fittings on the inner side of one of the enclosing elements of the frame and/or on a supporting bracket which is arranged in the frame interior. The enclosing elements of the frame as a rule form a box which completely encloses the compressed gas cylinders of the cylinder bundle. The compressed gas cylinders including the removal valves which are arranged on them and the pipeline system are protected against damage by said arrangement and, in addition, the box-shaped geometry makes space-saving transport and a compact placement of the cylinder bundles possible. It is therefore advantageous to fasten the fitting for pressure limitation to the inner side of one of the enclosing elements or on a supporting bracket which is possibly present within the enclosing elements, that is to say in the frame interior, and to connect it correspondingly to the remaining parts of the pipeline system.

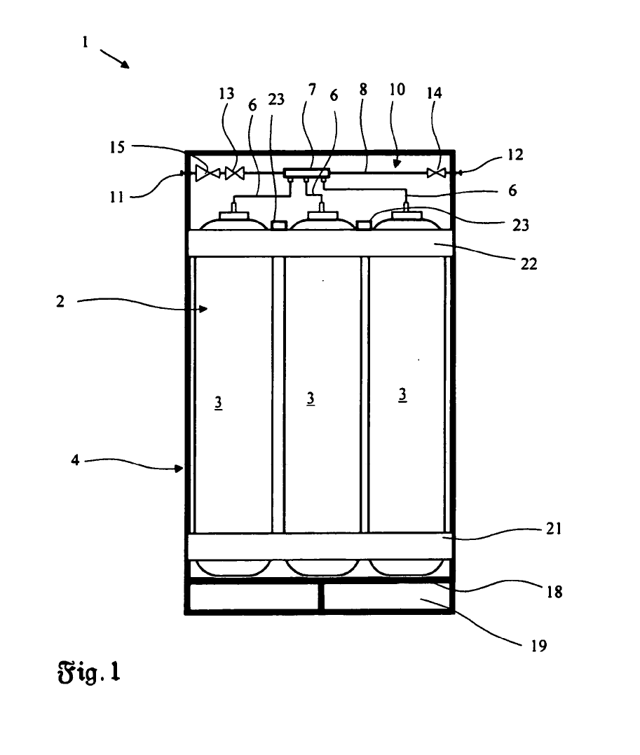

In the following text, one exemplary embodiment of the invention will be explained in greater detail using the drawing. The single FIGURE (FIG. 1) diagrammatically shows an arrangement according to the invention in a side view.

The arrangement 1 comprises a cylinder bundle 2 comprising, for example, six, eight, nine, twelve or eighteen compressed gas cylinders 3, which cylinder bundle 2 is received within a frame 4. The cylinders 3 are connected to a main removal line 8 by means of pipe or hose connections 6 via a connection distribution block 7. The main removal line 8, connection distribution block 7 and hose connections 6 are combined in the following text as pipeline system 10.

The main removal line 8 which extends transversely through the frame 4 is equipped at its two ends with connector ports 11, 12 which have means for connecting a gas supply system (not shown here) of a consumer, such as a flange or a thread. Both connector ports 11, 12 are assigned a shut-off fitting 13, 14, by way of which a flow connection to the respective connector port 11, 12 can be opened or closed. Furthermore, a pressure reducing device 15 is provided between the shut-off fitting 13 and the connector port 11. The pressure reducing device 15 reduces the pressure which prevails at the connector port 11 from the filling pressure of the cylinder bundle 2 to a value which is predefined by the pressure reducing device 15 or is set at the latter. The pressure reducing device 15 can also be arranged with an identical function between the shut-off fitting 13 and the connection distribution block 7. If, for example, the filling pressure of the cylinder bundle lies at 300 bar, a fitting which reduces the pressure to 200 bar can be selected as pressure reducing device 15. Accordingly, gas at a maximum pressure of 200 bar can be removed at the connector port 11. In contrast, the connector port 12 does not have a pressure reducing device; the gas can therefore be removed at said connector port 12 at the filling pressure of the cylinder bundle 2, that is to say 300 bar in the abovementioned example.

The frame 4 is preferably a welded construction of steel profiles and comprises, in a manner which is customary per se, a base 18 and a transport section 19 which is arranged below the base. Holding edges 21, 22 which run around on the frame 4 are provided in the region of the cylinder bodies of the compressed gas cylinders 3. Furthermore, in order to fix the compressed gas cylinders 3 and to increase the shock-proof property, supporting brackets 23 which are connected fixedly but releasably to the frame 4 can be provided, which supporting brackets 23 extend transversely through the frame 4 perpendicularly with respect to the plane of the drawing in the exemplary embodiment. All the parts of the pipeline system 10, including the pressure reducing device 15, are arranged within the outer circumference of the frame 4, in order to avoid damage during transport. The shut-off fittings 13, 14 and the pressure reducing device 15 are advantageously mounted fixedly, for example by screw connection, on the frame 4, for example on the inside on a steel profile of the frame 4 or on a supporting bracket 23.

### LIST OF DESIGNATIONS

1. Arrangement
2. Cylinder bundle
3. Compressed gas cylinder
4. Frame
5. -
6. Pipe connection
7. Connection distribution block
8. Main removal line
9. -
10. Pipeline system
11. Connector port
12. Connector port
13. Shut-off fitting
14. Shut-off fitting
15. Pressure reducing device
16. -
17. -
18. Base
19. Transport section
20. -
21. Holding edge
22. Holding edge
23. Supporting bracket

1. An arrangement for storing and transporting compressed gas, having a plurality of compressed gas cylinders which are mounted in a frame, a pipeline system which is connected to the compressed gas cylinders, and a removal connector which is assigned to the pipeline system, characterized in that the pipeline system is equipped with at least two removal connectors, at least one removal connector being assigned a fitting for pressure reduction for the possibility to remove gas at different removal pressures.

2. The arrangement as claimed in claim 1, wherein one removal connector is provided for removal at at least 300 bar and one removal connector is provided for removal at at most 200 bar.

3. The arrangement as claimed in claim 1, wherein the pressure limiting device/devices is/are arranged as a separate fitting on the inner side of one of the enclosing elements of the frame and/or on a supporting bracket which is arranged in the frame interior.

4. The arrangement as claimed in claim 2, wherein the pressure limiting device/devices is/are arranged as a separate fitting on the inner side of one of the enclosing elements of the frame and/or on a supporting bracket which is arranged in the frame interior.
